(19) United States
(12) Patent Application Publication
(10) Pub. No.: US 2009/0074976 A1
(43) Pub. Date: Mar. 19, 2009

(54) METHOD OF REDUCING MOTTLE AND STREAK DEFECTS IN COATINGS

(76) Inventors: Anthony J. Freking, White Bear Lake, MN (US); Jeffrey W. Hagen, Eagan, MN (US); Thomas J. Ludemann, Maplewood, MN (US); Kevin G. Moseley, Roseville, MN (US); Richard J. Pokorny, Maplewood, MN (US); Steven D. Solomonson, Shoreview, MN (US); Robert A. Yapel, Oakdale, MN (US)

Correspondence Address: 3M INNOVATIVE PROPERTIES COMPANY, PO BOX 33427, ST. PAUL, MN, 55133-3427, US

(21) Appl. No.: 12/174,818

(22) Filed: Jul. 17, 2008

Related U.S. Application Data
(60) Provisional application No. 60/972,275, filed on Sep. 14, 2007.

(51) Int. Cl. B05D 3/02

(52) U.S. Cl. 427/372.2

(57) ABSTRACT

The invention provides methods of reducing visible defects in curable coating compositions. In one embodiment, the method includes coating a curable composition onto a substrate, removing solvent from the curable composition, and heating the dried curable composition to a temperature at which the curable coating exhibits leveling flow. In another embodiment, the curable composition is coated onto a substrate, and then is heated to a temperature at which the curable coating exhibits leveling flow.

### RELATED APPLICATIONS

This application claims the benefit of U.S. Provisional Application No. 60/972,275, filed on Sep. 14, 2007.

### BACKGROUND

The present invention relates to methods for reducing visible defects such as mottle in coatings.

In some methods, the production of coated articles consists of applying a relatively thin film of a coating composition onto a substrate and drying the coating to remove any solvent and to form the final coating. Typically, drying gases are used at flow rates that are as high as possible to transfer heat to the coated article as efficiently and cost effectively as possible. However, such processes can result in a coating having visible surface defects, such as mottle.

In other processes, a curable coating is applied to a substrate, the coating is dried to remove any solvent at relatively low temperature combined with relatively low airflow, and then the coating is cured.

### SUMMARY

In one embodiment, the method of the invention provides a method for reducing the formation of visible defects in a surface of a coating composition on a substrate. The method comprises coating a curable composition containing a solvent onto a surface of a substrate, removing the solvent from the coated curable composition to form a dried curable coating and heating the dried curable coating to a temperature at which the curable coating exhibits leveling flow.

In another aspect, the above method further includes the step of curing the curable coating after the curable coating has exhibited leveling flow.

In an other aspect, method above wherein the curable coating has visible surface defects prior to exhibiting leveling flow and has a reduced amount of visible surface defects after exhibiting leveling flow.

In another embodiment, the invention provides method for reducing the formation of visible defects on a surface of a coating on a substrate comprising coating a substantially solventless curable composition onto a surface of a substrate to form a curable coating, the surface of the curable coating having visible defects, and heating the curable coating to a temperature at which the coating exhibits leveling flow, wherein in the surface of the coating has reduced visible defects.

### BRIEF DESCRIPTION OF THE FIGURES

FIG. 1 is an exemplary flow chart of a process that may be used with the methods of the invention;

FIG. 2 is a depiction of an exemplary process that may be used with methods of the invention; and

FIG. 3 is a depiction of a plot of viscosity vs. temperature for a monomer used in a formulation used in Example 1.

### DETAILED DESCRIPTION

As used herein:

“Mottle” means a visible irregular pattern or non-uniform density defect that appears blotchy when viewed. The pattern may or may not be oriented in one direction. The blotchiness may be gross or subtle and may appear to be different colors or shades of color;

“Leveling flow” means a flow of a coated curable composition which redistributes the coated curable composition over the substrate resulting in a coating having a more uniform surface or in a coating having a surface that appears to be more uniform;

“Curable composition” means a composition which polymerizes or solidifies to a final form via a curing step;

“Quiescent gas flow” means that the gas flow in the drying or solvent removal module or the heating module is low in the vicinity of the coated substrate and is uniform and desirably laminar or nearly so, that is, substantially laminar flow. Quiescent flow can be achieved by multiple means such as co-current flow (to minimize the differential speed difference between the moving substrate and the gas; laminar flow stabilizing such as via acceleration of the gas flow; gap drying; foraminous shields; and low velocity laminar flow;

“Low velocity gas flow” refers to gas flow of less than about 61.5 m/min (200 ft/min) and desirably, less than about 9.2 m/min (30 ft/min);

“Laminar flow” generally refers to streamline flow of an incompressible, viscous Newtonian fluid, with all particles of the fluid moving in distinct and separate lines so that turbulence are minimized or eliminated.

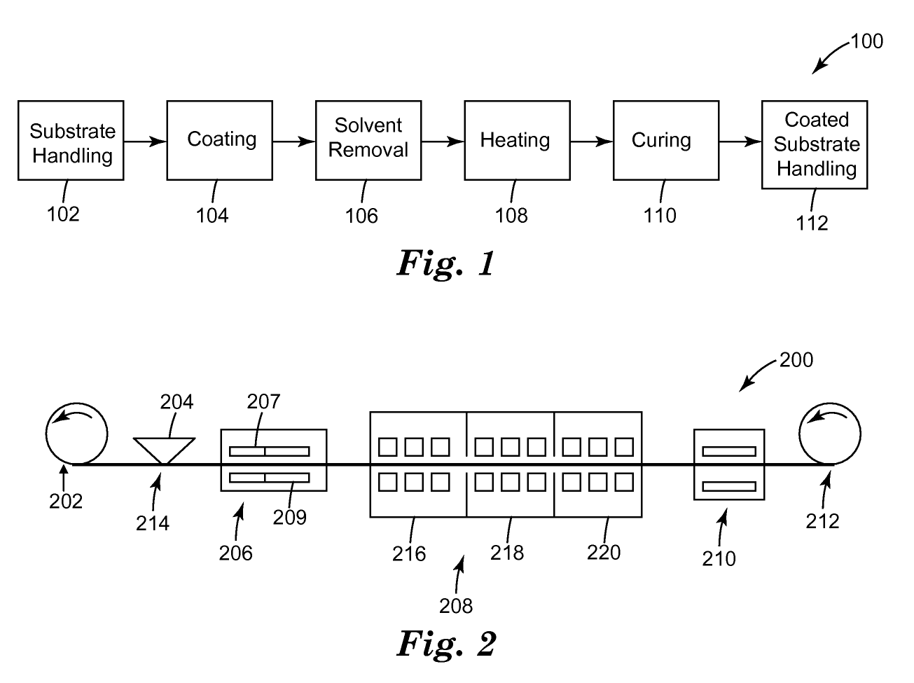

FIG. 1 shows a depiction of a flow diagram of a process for providing a coating on a substrate. Process 100 comprises substrate module 102, substrate coating module 104, drying or solvent removal module 106, heating module 108, curing module 110, and finished product winding module 112.

Substrate module 102 may include an unwinder roll, tensioning rolls, steering rolls, substrate treatment operations, and other web or substrate handling equipment. Substrate module may also include a substrate casting or extrusion line which directly provides a substrate. In another embodiment, substrate module may include a process or machine that provides substrates in the form of discreet sheets, for example glass panels, metal panels, or semiconductor wafers.

Coating module 104 coats the solvent-containing curable composition onto the substrate. The coating may be applied to the substrate using solvent coating methods such as using a coating die, roll coater, air knife coater, gravure coater, fluid bearing coater, blade coater, curtain coater, slide coater, and dip coater. There may be single or multiple layers of curable composition coated at the same time or consecutively. The solvent may be an organic or aqueous solvent, or may be a combination of both. In some embodiments, no solvent is utilized because the material is coatable at the required thickness and uniformity without dilution with a solvent.

Drying module 106 desirably removes all or substantially all of the solvent from the curable composition to form a dried curable coating on a surface of the substrate. The amount of solvent removed from the curable composition is dependent upon the type of solvent used, the amount of solvent, other components used in the composition, and the method or methods used to remove the solvent. Desirably, a “dried” or “substantially solventless” coating is a coating where 95% by weight or more, of the solvent has been removed. In another embodiment, the “dried curable coating” may desirably contain 5% by weight or less solvent, in other embodiments, 4, 3, 2, 1, 0.5 percent by weight or less solvent and including any amount or range within 0 and 5% by weight. In another embodiment where the curable composition is coated onto a substrate in “dried” form, a drying module or drying step is not or may not be utilized.

After the curable composition has been “dried”, the resulting dried curable coating may or may not contain visible mottle or other visible surface defects. Drying module 106 may include a single drying step or may include multiple drying steps. For example, the drying module may include one or two sided drying gas impingement, gap drying, co-current or counter current air flow on one or both sides of the coated substrate, infra-red heating, and heated plates on one or both sides of the coated substrate. The drying gas may be air, or an inert gas such as nitrogen, or low oxygen atmosphere using combustion gases or other non-oxidizing gases).

Other specific useful dryers for use in drying modules include floatation impingement dryers such as available from numerous vendors including ASI (Advance Systems Inc., 1031 Ontario Road, P.O. Box 9428, Green Bay, Wis. 54308-9428) and MegTEC (MEGTEC Systems Inc., 830 Prosper Road, De Pere, Wis. 54115). Such dryers may include slot bars, “TEC” bars, and Airfoil bars. In another embodiment, the drying module may be an idler supported oven including any of the above mentioned bars. Such dryers may include a perforated plate type impingement. Alternatively, such dryers may include parallel flow to the web/substrate (counter or co-current). Such dryers may also include infrared or microwave dryers. Useful dryers and drying modules are described in the literature. See for example, Coating and Drying Defects: Troubleshooting Operating Problems, Second Ed., by Edgar B. Gutoff, Edward D. Cohen, Wiley-Interscience, NJ 2006; Modern Coating and Driving Technology, (Advances in Interfacial Engineering Series), by Edward D. Cohen and Edgar B. Gutoff, VCH, NY 1992; Web Processing and Converting Technology and Equipment, by Donatas Satas, Von Nostrand Reinhold Co., NY 1984; and Liquid Film Coating—Scientific principles and their technological implications, by P. M. Schweizer and S. F. Kistler, Chapman & Hall, NY, 1997.

Heating module 108 heats the dried curable coating to a temperature at which the curable coating exhibits leveling flow. Once this temperature has been reached, the viscosity of the curable coating is reduced such that the heated coating levels or flows to form a surface free or substantially free of mottle and desirably other visible surface defects such as “streaks” and other gross non-uniform disturbances or patterns in the coating such as ribbing, seashore patterns, “chevron” patterns, bar marks, chatter, and bands. The viscosity needed for laminar flow of the heated composition depends upon the thickness of the dried coating, for example, thicker dried coatings will require a relatively lower viscosity to level the heated coating. Typically, the desired viscosity may be determined through experimentation with the particular curable composition and the particular heating module and process. However, if the viscosity of the heated curable coating is to low, areas having complete or partial removal of the curable coating may form. This is also called “dewetting.” Such dewetting can be reduced or prevented by using clean gas in the oven and using curable compositions having relatively low surface tensions, for example by adding a surfactant such as FC 4430 available from 3M Company, St. Paul, Minn. Dewetting can also be reduced via surface treatment of the surface of the web or substrate to increase its surface energy. Examples of such surface treatment include corona discharge treatment, flame treatments, chemical etchings, chemical surface treatments, and combinations thereof. The rate of leveling of the heated curable coating is dependent on the viscosity of the heated coating, the composition of the coating, and the thickness of the coating.

While not wanting to be bound be any particular theory, heating module 108 may be separate from the drying module described above, or may be a continuation of the drying module 106. Desirably, drying gas flow during the step of heating the curable coating is minimized, in other embodiments, quiescent so that once the curable coating has leveled and flowed, defects in the surface of the curable coating caused by the flow of drying gas are minimized or eliminated. Quiescent airflow in the heating module, particularly on the coated side of the substrate, may be attained for example by: using parallel flow of the gas to the moving substrate; minimizing the gas velocity via the existing controls for example, turning down the fan speeds; or using a gap drying device. Useful quiescent drying techniques are also disclosed in U.S. Pat. No. 6,015,593.

In another embodiment, the heating module 108 may also contain a zone or a mechanism to cool the coating and substrate to make the leveled and defect-reduced coating less susceptible to formation of new additional defects during subsequent web handling and curing operations. Such cooling should also be done in a quiescent airflow environment, particularly on the coated side of the web/substrate.

It is also understood that the atmosphere in the heating zone could be any suitable gas that does not degrade the coating. This could include air, nitrogen, inert gases, helium, neon, krypton, xenon, radon, argon, and chlorofluorocarbons such as those having the tradename FREON, available from E.I. du Pont de Nemours and Company Wilmington, Del.

Curing module 110 may or may not be present for use in the methods of the invention. Curing module cures the curable composition after any surface defects in the curable coating have been removed. Curing module may utilize visible light, UV, E-beam, or thermal energy to cure the curable composition and form a surface having minimal visible defects, in other embodiments, substantially free of visible defects, in other embodiments, free of visible defects.

The curable coating compositions used in the methods of the invention may include an initiator chemistry tuned to the curing radiation or heat. Some initiator chemistries may require a low oxygen or inert atmosphere during initiation and curing. Desirably, gas flow is minimized on the coated side of the substrate and/or the temperature of the coating on the substrate is kept low enough, that is, the viscosity of the curable coating is high enough, to prevent new coating defects, for example mottle, from forming prior to, or during the curing process.

In another embodiments, for example, high intensity UV radiation curing (such as available from Fusion Systems and others), it may be desirable to use a thermally controlled backup roll to keep the coating cool during curing. In other embodiments, low heat emitting curing devices such as UV-LED radiation sources can be used. In another embodiment, for example, heat curing it is desirable to maintain quiescent gas flow in the curing module 110. Such processes may also include minimizing gas flow at web slots (if present) between process zones.

Product handling module 112 collects or further processes the coated substrate or both. For example, product handling module may comprise a winder and other processing equipment such as a laminator, a liner unwinder, slitter, or packager.

The methods of the invention may be used with any typical commercially used coating and drying processes capable of providing a coated substrate using a curable composition, removing the solvent from the coated curable composition, and heating the dried curable composition to its ‘flow’ point, and allowing the flowing composition to level.

The methods of the invention may be used with many curable compositions containing curable materials. Examples of useful curable materials include ionizing curable polymeric materials for example, photopolymerizing prepolymers and monomers. Usable curable prepolymers include acrylic prepolymers with acryoyl group such as urethane acrylate, epoxy acrylate, melamine acrylate, polyester acrylate, and the like. Usable curable monomers include single functional acrylic monomers such as 2-ethylhexyl acrylate, 2-hydroxyethyl acrylate, 2-hydroxypropyl acrylate, butoxypropyl acrylate and the like, two functional acrylic monomers such as 1,6-hexandiol acrylate, neopentylglycol diacrylate, diethyleneglycol diacrylate, polyethyleneglycol diacrylate, hydroxypivalate neopentylglycol acrylate and the like, and multifunctional acrylic monomers such as dipentaerythritol hexaacrylate trimethylpropane triacrylate, pentaerythritol triacrylate, and the like. Such acrylates can be used individually or in combinations of two or more.

Usable radical photopolymerization initiators include benzoine ether system, ketal system, acetophenone system, tioxanthone system, and the like. Usable cation-type photopolymerization initiators include diazonium salts, diaryl iodonium salts, triaryl sulfonium salts, triaryl pyrilium salts, benzine pyridinium tiocyanate, dialkyl phenancyl sulfonium salts, dialkyl hydroxy phenylphosphonium salts, and the like. These radical type photopolymerization initiators and cation type photopolymerization initiators can be used alone or as a mixture thereof. The photopolymerization initiator is required for the ultraviolet (UV) radiation curable resins but can be omitted for the high-energy electron beam radiation curable resins.

Solvents that may be used in curable compositions used in methods of the invention include single solvents or blends of solvents such as, but not limited to toluene, tetrahydrofuran, acetone, IPA, methanol, ethanol, ethyl acetate, water, methylethyl ketone (MEK), and combinations of such solvents.

The curable compositions of the invention may also comprise other components such as particulates. Examples of particulates include beads, particles, silica particles, and ceramic particles. Such particles may be substantially transparent or transparent.

Another substrate coating process which may utilize methods of the invention is shown in FIG. 2. Coating process 200 includes substrate unwinder 202, coating apparatus 204, gap dryer 206, zoned drying gas oven 208, UV curing apparatus 210, and coated substrate winder 212. In operation, the substrate 214 is unwound from the substrate unwinder 202 and is coated with a solvent-containing curable composition by the coating apparatus 204. The substrate coated with the curable composition passes through a gap dryer 206 having thermally controlled platens 207, 209 above and below the moving coated substrate to remove solvent from the coated curable composition. After passing through the gap dryer 206, any residual solvent in the coated composition is removed in zones 1 and 2 (216, 218) of the zoned drying gas oven 208 to from a dried curable coating. The dried curable coating is heated in zone 3 (220) to a temperature such that the viscosity of the curable coating is reduced such that the coating levels or flows to form a surface free or substantially free of mottle. Desirably, the flow of drying gas during the “flow” of the curable coating is minimized to prevent defects in the surface of the curable coating caused by the flow of drying gas. The coated substrate having a substantially mottle free surface passes through the UV curing apparatus to cure the coated composition and is wound on a substrate winder.

The methods of the invention can be used to make coated substrates for use in articles used in many different industries. For example, the methods of the invention may be used to make coated substrates for use in optical articles without a matte finish, such as gain diffusers and brightness enhancement films; abrasive articles; graphics articles; medical articles; sensors; component articles for fuel cells; photographic articles; and medical imaging articles.

### EXAMPLE

### Viscosity of Monomer Vs. Temperature

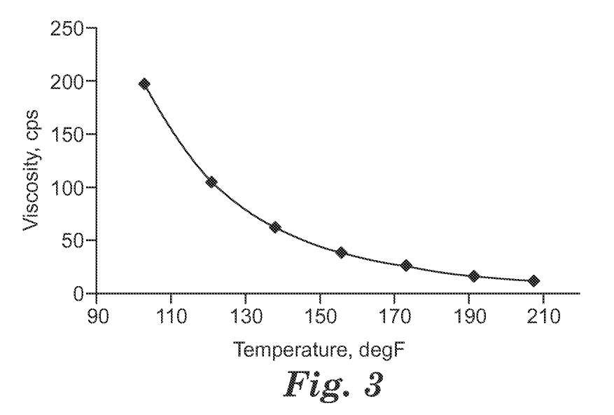

The SR355 monomer viscosity was fit to a power model where the viscosity=(2×10¹⁰)(x^{-3.9881}). The model indicated that the viscosity of the 100% solids monomer decreases with temperature and would exhibit leveling flow at oven temperatures used below. The viscosity vs. temperature data are shown in FIG. 3

### Curable Coating Composition A:

| | | | Amount |
|---|---|---|---|
| Component | Description | Available From: | (parts by weight) |
| SR355 | Tetrafunctional | Sartomer, (Exton, | 99 |
| | acrylate monomer | PA). | |
| ESACURE | UV photoinitiator | Lamberti USA, | 1 |
| ONE | | (Lima, PA) | |
| MX300 | PMMA particles, 3 | Esprix, (Sarasota, | 2 |
| | micrometer diameter | FL) | |
| MEK | Solvent | | 341 |

### Example 1

A coated substrate was made using a process as materially shown in FIG. 2. Coating Composition A was coated onto a substrate (polyethylene terephthalate (PET), DuPont Melinex 618-500, primed, available from DuPont Teijin Films U.S. Limited Partnership, Hopewell, Va.) at a level of 23 weight percent solids using a stirred pressure pot at a thickness of about 1.6, 1.8, and 2 micrometers. An air knife placed right after the coating die was used to induce mottle caused by air turbulence.

Top Air flow measurements were performed using an anemometer. Bottom air flow measurements were calculated using Bernoulli's Equation at 1.25 in of water column. The substrate was corona treated prior to applying the coating composition.

The process parameters held constant are shown below in Table 1.

TABLE 1

| | |
|---|---|
| Line Speed | 50 ft/min (15 m/min) |
| Retraction | 1.625 inches (4.123 cm) |
| Gas Drying | 120° F. (48.8° C.); top air flow-70 ft/min (21 m/min); |
| Oven - Zone 1 | bottom air flow all zones - 4480 ft/min |
| | (1366 m/min) |
| Gap Dryer - | Bottom: zone 1 = 120° F., zone 2 = 150° F. |
| | Top: zone 1 = 72° F., zone 2 = 72° F. |
| UV Curing | H Bulb, N₂ Purged, backup roll @ 70° F. |

The process parameters that were varied are shown below in Table 2.

TABLE 2

| Condition | A | B |
|---|---|---|
| Gap Dryer | Bypassed | Bottom: zone 1 = 120° F., |
| | | zone 2 = 150° F. |
| | | Top: zone 1 = 72° F., |
| | | zone 2 = 72° F. |
| Gas Drying Oven - | 70 ft/min | 150 ft/min (46 m/min) |
| Zone 1 and 2 Top | (21 m/min) | |
| Air Flow | | |
| Gas Drying Oven - | 65.55° C. (150° F.) | 120° C. (248° F.) |
| Zones 2 and 3 | | |
| Air Disturbance | Off | On @ 250 ft/min (76 m/min) |
| Air Corona | Off | 300 mJ/cm² |

Table 3 below shows a summary of sample runs, process conditions used, and results. Each run was done with coating thicknesses of 1.6, 1.8, and 2 micrometers.

TABLE 3

| | | Zone 2 | | | | | |
|---|---|---|---|---|---|---|---|
| | | and 3 | | | | Mottle | Streaks |
| | Gap | Air | Zone 2 and 3 | Air | Air | (1 = severe; | (1 = severe; |
| | Dryer | Flow | Temperature | Disturbance | Corona | 5 = none) | 5 = none) |
| 1 | A | A | A | A | B | 3 | 2 |
| 2 | A | A | A | B | A | 2 | 4 |
| 3 | A | B | A | A | A | 5 | 3 |
| 4 | A | B | A | B | A | 2 | 4 |
| 5 | B | A | A | A | A | 5 | 3 |
| 6 | B | A | A | B | B | 5 | 3 |
| 7 | B | B | A | A | B | 5 | 4 |
| 8 | B | B | A | B | A | 3 | 4 |
| 9 | A | A | B | A | A | 5 | 4 |
| 10 | A | A | B | B | B | 2 | 4 |
| 11 | A | B | B | A | B | 5 | 4 |
| 12 | A | B | B | B | A | 3 | 4 |
| 13 | B | A | B | A | B | 5 | 3 |
| 14 | B | A | B | B | A | 4 | 4 |
| 15 | B | B | B | A | A | 5 | 4 |
| 16 | B | B | B | B | B | 3 | 4 |

It is to be understood that although various embodiments of the present invention have been described, persons having skill in the art will recognize that changes may be made in form and detail without departing from the spirit and scope of the invention.

What is claimed is:

1. A method for reducing the formation of visible defects in a surface of a coating composition on a substrate comprising the steps of:
coating a curable composition containing a solvent onto a surface of a substrate;
removing the solvent from the coated curable composition to form a dried curable coating; and
heating the dried curable coating to a temperature at which the curable coating exhibits leveling flow.

2. A method for reducing the formation of visible defects on a surface of a coating on a substrate comprising the steps of:
coating a substantially solventless curable composition onto a surface of a substrate to form a curable coating, the surface of the curable coating having visible defects; and
heating the curable coating to a temperature at which the coating exhibits leveling flow, wherein in the surface of the coating has reduced visible defects.

3. The method of claim 2 wherein the curable composition comprises a multifunctional acrylate.

4. The method of claim 1 wherein the solvent is an organic solvent.

5. The method claim 1 wherein the solvent is removed from the curable composition using a drying gas and a temperature controlled platen.

6. The method claim 2 wherein heating the curable coating is by using a drying gas with a flow and the flow of the drying gas is quiescent during the step of heating the curable coating.

7. The method of claim 1 wherein the solvent is removed from the curable composition using a combination of a gap dryer and a multi-zone drying gas oven.

8. The method of claim 2 wherein the substrate is supplied via a roll, an extrusion process, a casting process, or in the form of a sheet.

9. The method of claim 1 further comprising the step of surface treating the substrate prior to coating the curable composition.

10. The method of claim 1 wherein the curable composition is coated onto the substrate using a coating die, a roll coater, a gravure coater, or a spray coater.

11. The method claim 1 wherein the solvent is selected from the group consisting of toluene, tetrahydrofuran, acetone, IPA, methanol, ethanol, ethyl acetate, water, methylethyl ketone (MEK), and combinations of such solvents.

12. The method of claim 1 further comprising the step of curing the curable coating after the curable coating has exhibited leveling flow.

13. The method of claim 1 wherein the curable coating has visible surface defects prior to exhibiting leveling flow and has a reduced amount of visible surface defects after exhibiting leveling flow.

14. The method of claim 1 further comprising the step of cooling the curable coating after the curable composition has exhibited leveling flow.

15. The method of claim 1 further comprising the step of curing the curable coating after the curable coating has exhibited leveling flow wherein gas flow during the curing step is quiescent.

16. The method of claim 2 wherein the curable coating is heated using radiant heating, infrared heating, or microwave heating.

17. The method of claim 1 wherein the curable coating is cured using visible light, UV radiation, UV-LED radiation, E-beam, or thermal energy.
